(19) United States
(12) Patent Application Publication
(10) Pub. No.: US 2009/0016882 A1
(43) Pub. Date: Jan. 15, 2009

(54) Apparatus for Capturing Kinetic Energy

(76) Inventor: Harry K. Robinson, Jupiter, FL (US)

Correspondence Address: ST. ONGE STEWARD JOHNSTON & REENS, LLC, 986 BEDFORD STREET, STAMFORD, CT, 06905-5619, US

(21) Appl. No.: 12/171,908

(22) Filed: Jul. 11, 2008

Related U.S. Application Data
(60) Provisional application No. 60/949,708, filed on Jul. 13, 2007.

(51) Int. Cl. F03B 7/00; F03D 3/06

(52) U.S. Cl. 416/131

(57) ABSTRACT

An apparatus for capturing kinetic energy from wind and water current speeds is disclosed for use in both commercial and residential applications generally comprising a vertical axis spindle, a plurality of structural arms attached to said spindle, and a plurality of panels rotationally attached to the ends of their respective structural arms to provide for controlled flipping action, thereby enabling operation in diverse intensity wind and water currents. In further embodiments, the apparatus may comprise mechanical, pneumatic or hydraulic mechanisms for dampening the contact points between the panels and the hinge assemblies as the panels reach their open positions at the certain angle to their respective structural arms, and between the panels and their respective structural arms as the panels rotate to their folded position parallel to the structural arms.

### CROSS-REFERENCE TO RELATED APPLICATIONS

This application claims priority benefits under 35 U.S.C. §119(e) of the U.S. Provisional application No. 60/949,708, filed on Jul. 13, 2007.

### FIELD OF THE INVENTION

The present invention relates to a windmill structure and more particularly to a windmill and/or watermill on a vertical axis, containing hinged panels with a controlled “flipping action,” that captures kinetic energy from a wide range of wind and water current speeds.

### BACKGROUND OF THE INVENTION

Since ancient times, men have captures the power of the wind for a variety of purposes. The history of wind power shows a general evolution from the use of simple, light devices driven by aerodynamic drag forces; to heavy, material-intensive drag devices; to the increased use of light, material-efficient aerodynamic lift devices in the modern era. The oldest known windmills were crude, simple devices used in the 7th century by the Persians. Europeans made extensive use of the windmill beginning in the 12th century, providing mechanical energy for pumping water, sawing lumber, and grinding grain. In the United States, the windmill was used to pump water on homesteads across the American frontier. In the late 20th century, windmills were developed to convert wind energy into electric power.

Many countries began exploring alternative sources of energy during the oil shortages of the 1970s. As improvements in wind energy technology have evolved, the modern wind energy industry has emerged. Concern about global warming also spurred interest in wind energy as an alternative to burning fossil fuels, which release greenhouse gases into the atmosphere. Increasingly, modern wind turbines produce electric power as efficiently as other power generation technologies.

As one would expect, the art in the area of windmills is abundant. However, many modern windmills face a whole array of structural problems, thereby preventing widespread use of this significant alternative source of energy. For example, one of the major obstacles for developing wind energy is finding suitable terrain and wind conditions. The windmills constructed for the purpose of operating in general velocity of winds are generally not strong enough to withstand high speed winds. On the other hand, windmills manufactured solidly enough to withstand strong winds generally are incapable of efficient operation in average velocity winds. Thereby, there exists a need for a windmill that is capable of operating in diverse intensity of wind speeds.

One of the devices that attempts to address this problem is disclosed in U.S. Pat. No. 7,118,341, issued to Hartman, entitled “Self Adjusting Sail Vertical Shaft Windmill.” Hartman discloses a windmill comprising a vertical shaft with mounted sails wherein said sails can self adjust to interact with the wind in such a way as to power the windmill, as well as relieve themselves from winds that are too severe, while maintaining continuous operation. This objective is achieved through the use of springs attached to the sails wherein the sails that are broadside to the wind are relieved by stretching the springs and thus reducing the profile of the broadside sails to the wind. However, the Hartman windmill involves a complex combination of mechanical components, thereby likely necessitating high production costs. Additionally, the particular design of the windmill makes it impracticable, if not impossible, to be used for extracting energy from water currents, as the multiple mechanical components comprising the windmill are more prone to damage in a more dense medium such as water.

Another drawback of previously known windmills is that they have to be aligned with the windstream to enable operation, thus considerably limiting the utility of such windmills. A windmill device disclosed in U.S. Pat. No. 6,688,842 to Boatner, entitled “Vertical Axis Wind Engine,” attempts to cure this problem by providing the device having “free flying” airfoils that self position according to the local dynamic conditions to which they are subjected. Boatner describes a windmill which includes a support structure, a rotor mounted rotatably on the support structure for rotation about a vertical axis, and at least one airfoil mounted on the rotor for pivotal movement about the pivotal axis. The rotor includes components for limiting pivotal movement of the airfoil to first and second limits. The airfoil is free to pivot about the pivotal axis intermediate to first and second limits of pivotal movement thereby enabling the airfoil to align the angle-of-attack axis according to the wind. However, the Boatner windmill lacks any mechanical, pneumatic or hydraulic means for assistance in control of the rotational movement of the airfoils under high speed wind conditions by mechanically pulling the airfoils into a position of least wind resistance, thereby enabling the windmill to operate in a diverse intensity of wind speeds. Furthermore, the design of the airfoils wherein the pivotal axes of said airfoils are located one-third of the way back from the leading edge of the airfoils does not provide for optimal efficiency of the windmill as it does not take advantage of the possible momentum that can be added to the rotation of the windmill/watermill by a flipping action of the airfoils/panels achieved through positioning of the pivotal axes of the airfoils/panels on the leading edge of said airfoils/panels thus allowing the wind or water current to flip the airfoils/panels open.

Still another windmill system is disclosed in U.S. Pat. No. 6,926,491, issued to Migler, entitled “Vertical Axis Wind Turbine with Controlled Gybing.” Migler discloses a device for capturing electricity comprising sails that rotate around a vertical tower. As the sails rotate, the sails moving toward the wind are automatically feathered, and the sails moving away from the direction of the wind are prevented from being feathered by sail restraints. An inner sail restraint positions each sail so that the sail gybes at an earlier time than would otherwise occur. An outer sail restraint “catches” the sail as it gybes, capturing much of the energy of the gybe, adding additional rotational force. Although the windmill disclosed in Migler provides an effective solution for capturing the energy of the wind, its structural design is not as durable as the design of the present invention, and thus is not likely to be suitable for use in water currents. Additionally, the device in Migler comprises multiple components, which in turn increases manufacturing costs and limits its application in a variety of settings.

### SUMMARY OF THE INVENTION

Accordingly, it is an object of the present invention to provide a windmill/watermill mechanism with a minimal number of moving parts of relatively low production cost.

It is a further object of the present invention to provide a device capable of operating in diverse intensity wind and water speeds.

It is a further object of the present invention to provide a windmill/watermill wherein a direction of the rotation can be easily changed in the manufacturing process.

It is yet a further object of the present invention to provide a device capable of operating in both water and air for superior capture of the kinetic energy from water and air currents over any known windmills/watermills.

It is a further object of the present invention to provide a device comprising structural arms and panels attached at the end of their respective structural arms having a design that enables said windmill/watermill to be manufactured in a wide variety of sizes, thereby increasing the potential uses within both residential and commercial applications.

It is a further object of the present invention to provide a windmill/watermill capable of self-adjusting to the air or water current direction and therefore not requiring a vane or other mechanism to adjust to differentials in direction of the current.

In order to overcome the deficiencies of the prior art to achieve at least some of the objects and advantages listed, an apparatus for capturing kinetic energy is provided, comprising a vertical axis spindle; a plurality of structural arms having proximal ends attached to the vertical axis spindle; and a plurality of panels wherein the panels are rotatably attached to distal ends of their respective structural arms along a vertical pivotal axis at remotest position from said spindle for movement between a folded position horizontally alongside their respective structural arms and an open position angled to their respective structural arms, wherein the pivotal axis extends vertically along an edge of each panel.

In one embodiment, the device may be used to capture kinetic energy from wind. In another embodiment, the device may capture kinetic energy from any source of fluid energy, such as water currents.

The device may comprise structural arms with a cross support design to enable said structural arms to hold the necessary weight of the various desired panel sizes, thereby increasing potential utility and output of the present invention.

The device may also comprise a plurality of hinge assemblies for rotatable attachment of the panels to the distal ends of their respective structural arms.

The device may further comprise panels that swing out approximately 90° to 135° from the structural arms for maximum efficiency. The structural arms are may comprise a lightweight tubing material, and each panel may comprise a frame and material stretched across the frame. The frame may comprise a lightweight tubing material, and the material may be synthetic sail material.

The panels may also comprise a flat solid material or hollow braced airfoil design, and have a shape designed to reduce resistance to currents and to assist in pulling the panels back into the structural arms.

In addition, the device may further comprise a plurality of struts for dampening contact points between the panels and the hinge assemblies as the panels reach the open position angled to the respective structural arms and between the panels and their respective structural arms as the panels rotate to the folded position parallel to their structural arms. The struts may further be engaged to the panels back to the folded position horizontally alongside their respective structural arms to control rate of speed of the rotational movement of the panels. The struts may be mechanically, hydraulically or pneumatically actuated.

Yet further, the device may comprise a rotary actuator fitted within each hinge assembly and engaged to dampen contact points between said panels and said hinge assemblies as the panels reach said open position angled to said respective structural arms, and between said panels and said respective structural arms as the panels rotate to said folded position parallel to the structural arms, and to pull said panels back to said folded position horizontally alongside said respective structural arms to control rate of speed of the rotational movement of said panels.

The device may also comprise hinge assemblies fitted with high quality ball bearings to allow the panels to easily rotate to achieve the least level of resistance.

In another embodiment, the device for capturing kinetic energy from wind and water speeds is provided, comprising a vertical axis spindle; a plurality of structural arms with proximal ends attached to the vertical axis spindle; a plurality of panels rotatably attached to distal ends of their respective structural arms along a vertical pivotal axis at remotest location from the spindle for movement between an open position angled to their respective structural arms and a folded position horizontally alongside their respective structural arms, wherein the pivotal axis extends vertically along an edge of each said panel; and mechanically actuated struts arranged to dampen contact points between the panels and the hinge assemblies as the panels reach the open position angled to their respective structural arms, and between the panels and their respective structural arms as the panels rotate to the folded position parallel to the structural arms, and to pull the panels back to the folded position horizontally alongside their respective structural arms to control rate of speed of the rotational movement of the panels.

In yet another embodiment, the apparatus for generating power is provided, comprising a vertical axis spindle; a plurality of structural arms with proximal ends attached to the vertical axis spindle; a plurality of panels that are rotatably attached at their edges to distal ends of their respective structural arms along a vertical pivotal axis at remotest location to the spindle for movement between a folded position horizontally alongside their respective structural arms and an open position angled to their respective structural arms; and an energy converting system coupled to the spindle for converting first type of energy into second type of energy.

The energy converting system may comprise a transmission connected to the spindle, and a power generation system coupled to the transmission.

Other objects of the invention and its particular features and advantages will become more apparent from consideration of the following drawings and accompanying detailed description.

### BRIEF DESCRIPTION OF THE DRAWINGS

FIG. 1 is a three dimensional perspective view of an apparatus for capturing kinetic energy showing a vertical axis spindle, structural arms, hinge assemblies, and panels.

FIG. 2 is a front view of a structural arm of the apparatus of FIG. 1.

FIG. 3 is a front view of a panel of the apparatus of FIG. 1.

FIGS. 4-12 are top views of the apparatus of FIG. 1 showing various positions of the panels and the structural arms in the clockwise rotation of the apparatus.

FIG. 13 is a top view of a hinge assembly of apparatus of FIG. 1, showing a fixed structural arm and a swiveling panel.

FIG. 14 shows a possible arrangement for transferring the rotating power of the apparatus of FIG. 1 through its vertical axis spindle.

FIG. 15 is a perspective view of a hydraulic strut that could be attached to the panel of the apparatus of FIG. 1 to enable said apparatus to withstand higher speed winds or water currents.

FIG. 16 is a perspective view of a rotary actuator that could be incorporated into the hinge assembly of the apparatus of FIG. 1.

### DETAILED DESCRIPTION OF THE INVENTION

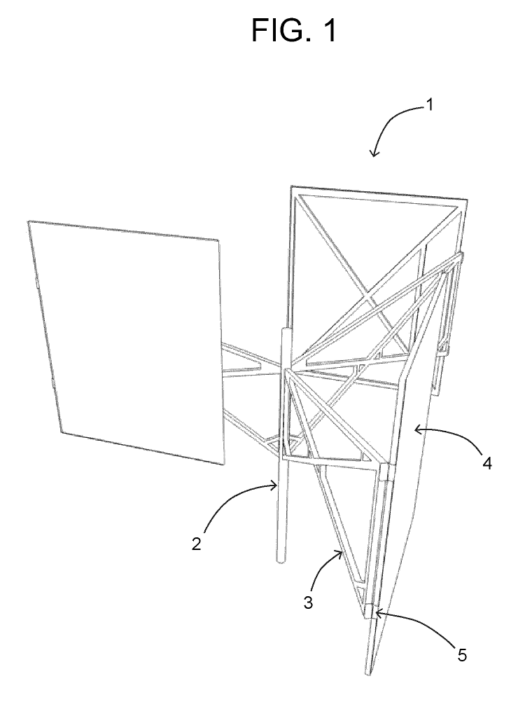

An important aspect of the present invention is the use of multiple large panels with a controlled “flipping action,” allowing one to easily move the panels using either wind or water, herein referred to as “wind” currents, at various speeds. A three-panel system (shown in FIG. 1) proved to work best in this small array, but a two- and a four-panel system have also been tested and worked under the same physical law principles.

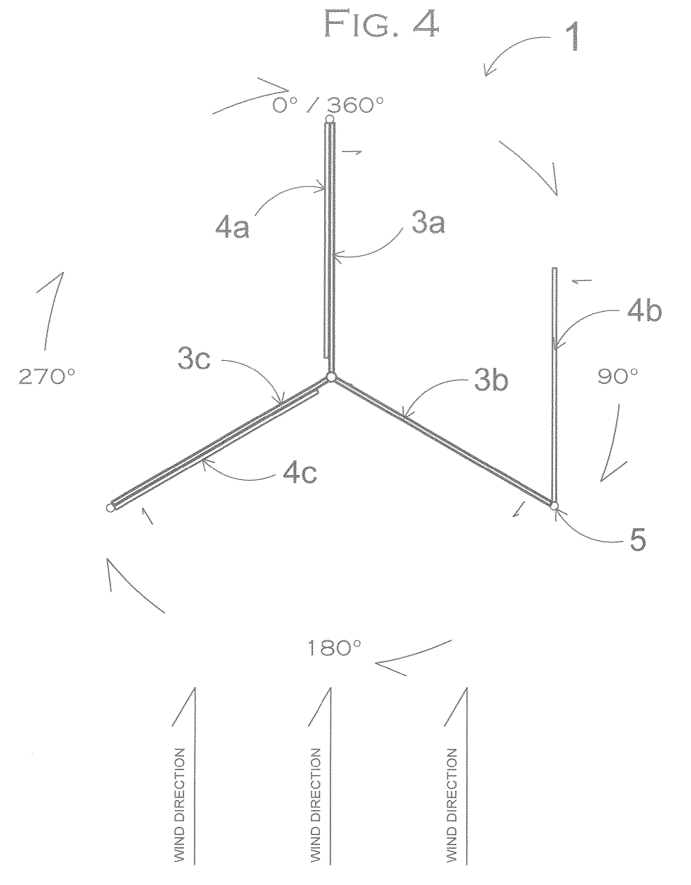

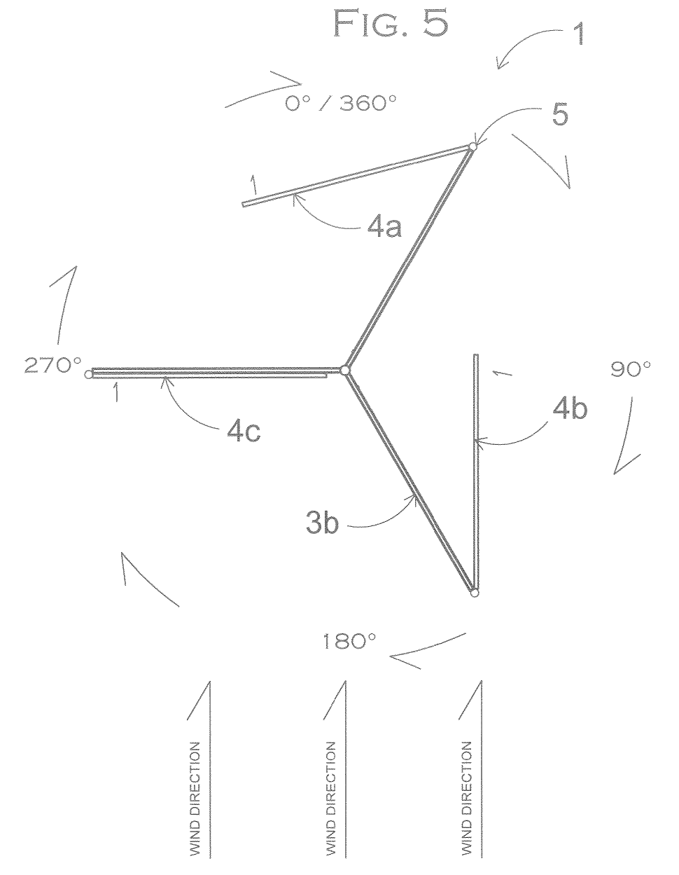

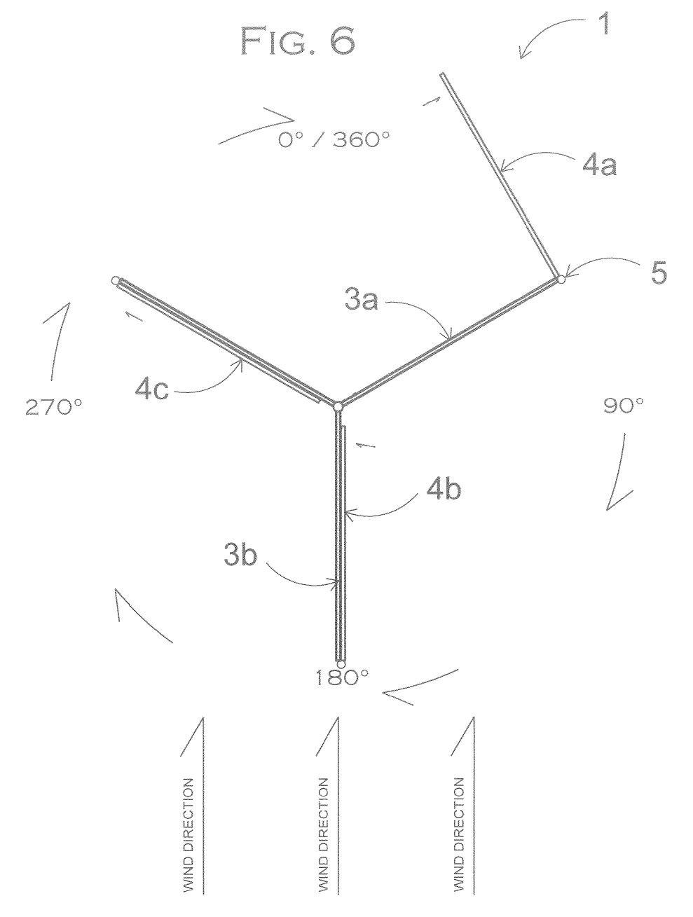

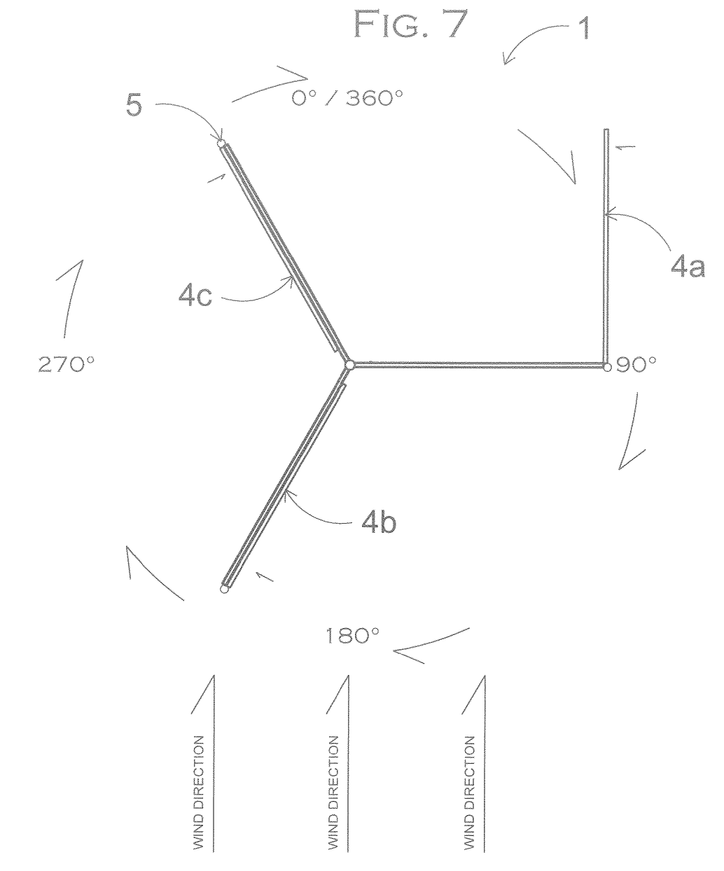

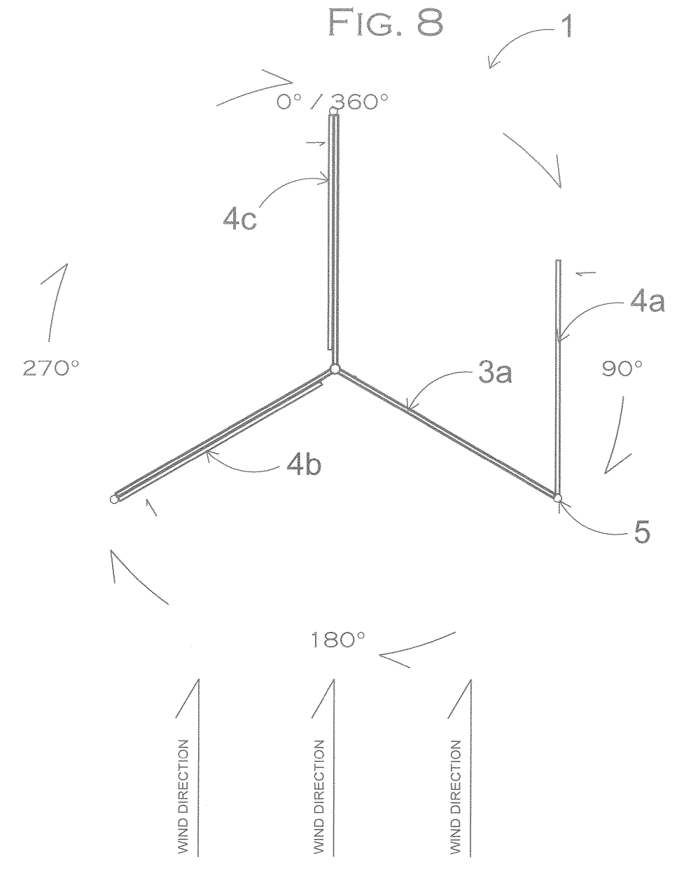

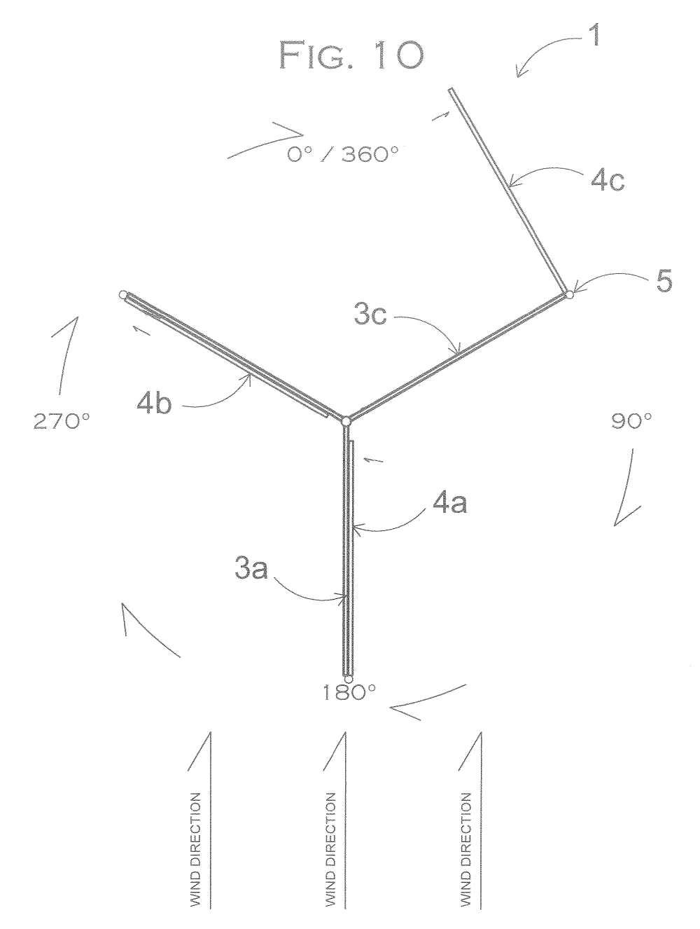

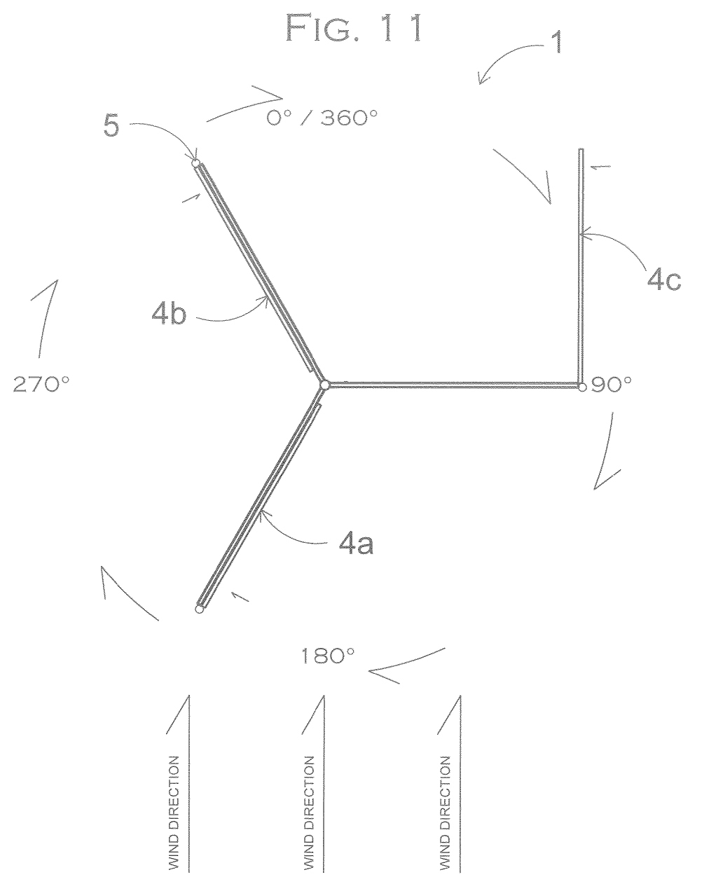

From an overhead view, each panel 4 acts as a sail through the 180° to 360° positions, (see panel 4c in FIGS. 4 & 5 and panels 4b & 4c in FIG. 7) with the panels and their arms 3 serving as the primary drivers to the clockwise rotation of the apparatus 1, thereby harnessing the wind's or water current's kinetic energy. Beginning at the 0° position in the 360° full rotation, (see FIG. 4), the wind or water current will begin to flip/swing panel 4 out from its hinged axis point away from its structural arm 3 (see panel 4a in FIG. 5), with the momentum of the flipping action and the wind/water current assisting in driving the rotation of the apparatus 1 as it hits its 90° stop (see panel 4a in FIG. 6). Once it has flipped to its 90° stop, the panel 4 starts to align horizontally with the wind's or water current's direction (see panel 4a in FIG. 6), thereby limiting its resistance aerodynamically as it tracks back against the wind/water current (see panel 4a in FIGS. 7, 8 & 9), as it goes from its 0° to 180° positions in the rotation. Once it reaches its 180° position in the rotation (see FIG. 10), the panel 4 has gone back to its horizontal position and then begins to act as a primary or second driver in the rotation (see panel 4a in FIG. 11).

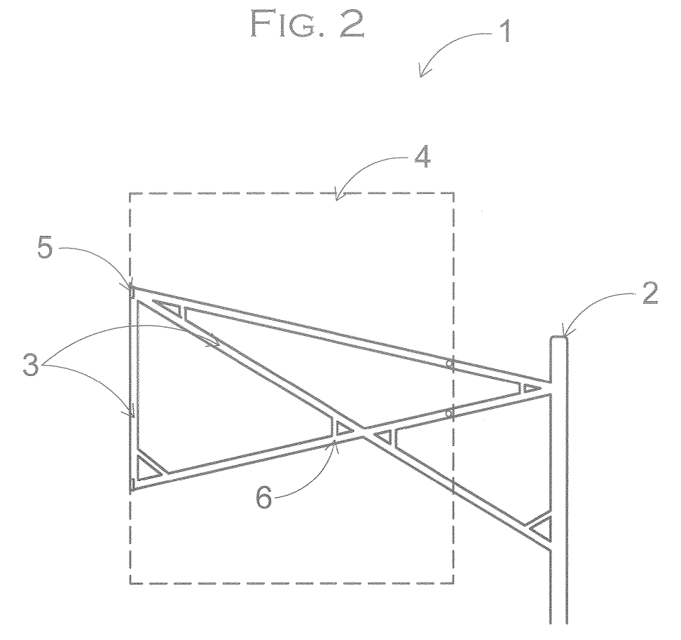

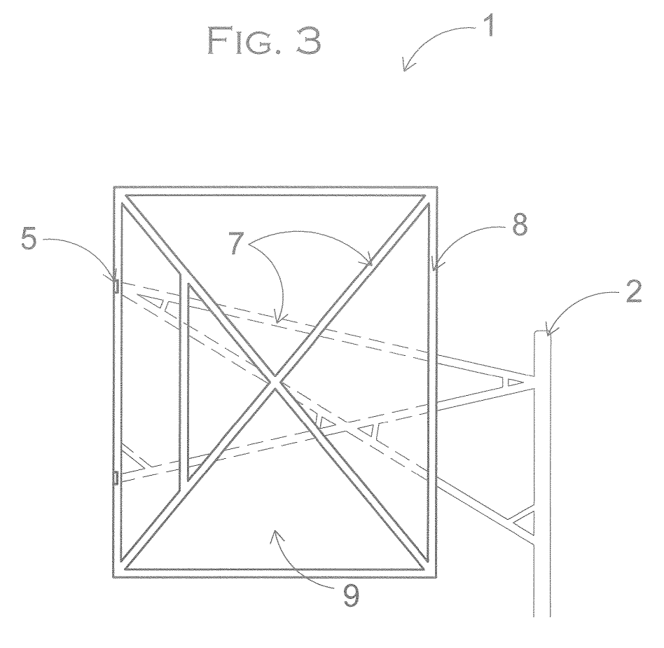

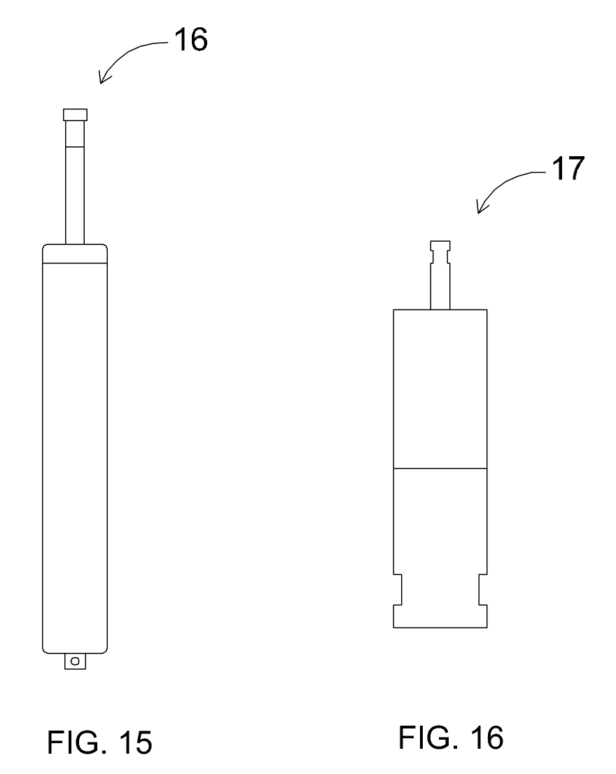

The apparatus 1 is designed to withstand high wind or water current speeds. Under such conditions, the centrifugal momentum of the spinning apparatus 1 causes the panels 4 to stay open after they reach their 90° ± stops. This causes greater resistance against the wind/water current (see FIG. 7), slowing down the rotational speed of the apparatus 1. The size of the apparatus, the size of the panels, the range of wind/water current speed, and load from various forms of transmission to the desired usage all play important roles in this action occurring. This action, however, can be minimized or eliminated by adding mechanical, pneumatic or hydraulic actuated struts or other known mechanisms, herein referred to as “hydraulics” (see FIG. 15), to pull the panels 4 in towards their structural arms 3 as they go from the 90° to the 180° portion of their rotation (see panel 4b in FIGS. 4, 5 & 6). Additionally, a physical method, such as air foil/winged shape panels attached at the end of each structural arm 3, similar to the flat panels 4, (see FIGS. 2, 3 & 13), can use the lift generated by the winged panel design to pull the panel 4 back into the structural arm 3 between the 90° and 180° positions in the rotation. Once the panels 4 reach the 180° point and are aligned horizontally with their structural arms 3, the wind or water current will keep them in line with the arms until they reach the 0° point in the rotation. The cycle has then reached its end point and begins again as it passes once again through the 0° position.

FIG. 1 is a three dimensional perspective view of an apparatus for capturing kinetic energy 1, showing a vertical axis spindle 2, structural arms 3, hinge assemblies 5, and panels 4 according to a preferred embodiment of the invention. The panels 4 are attached to distal ends of their respective structural arms 3 via a ball bearing inside hinge assembly 5. All the structural arms 3 are attached directly to the vertical axis spindle 2.

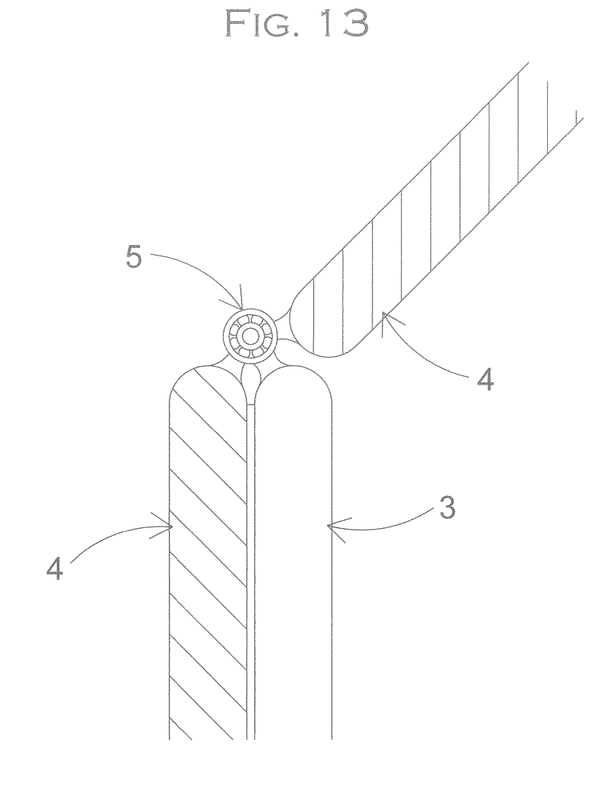

FIG. 2 is a more detailed illustration of a single panel 4 and its structural arm 3 of the apparatus 1. The size of the apparatus 1 is limited to the weight and size of the panels 4, the necessary cross support design strength of the structural arms 3 holding the panels 4, and the area where the apparatus 1 will be placed. Accordingly, the size and corresponding dimensions of the panel 4 can be varied based on costs and material considerations, providing for a higher utility of the apparatus 1. The structural arm 3 comprises a cross support bracing system 6 to provide the necessary strength and rigidity to adequately hold panels of various sizes. Each panel 4 is attached to the distal end of its structural arm 3 (see FIGS. 2 & 13) by an inside ball-bearing hinge 5, much like a standard door hinge, but with bearing, that allows the panel 4 to fold horizontally alongside the arm 3, yet only allows it to flip/swing open to a 90° to 135° position to its structural arm 3 (see FIG. 13). Although attachment of the panels 4 at their leading edges has thus far shown greater efficiencies, it is not necessary to attach the panels 4 at their leading edges. They may be attached at various points close to the edges so as to maintain the necessary flipping action throughout the 0°/360° positions. Note that the 90° stop position of each panel may not be the optimum stopping point and that maximum efficiency may be 45° farther than 90° from its structural arm, depending on wind or water current velocity, strength and size of the panels. For maximum efficiency, the hinges 5 and the vertical axis spindle 2 should be fitted with ball bearings 10 or lubricated bushings (see FIG. 13). The center spindle for the vertical axis 2 should also be fitted with high quality ball bearings to maximize efficiency.

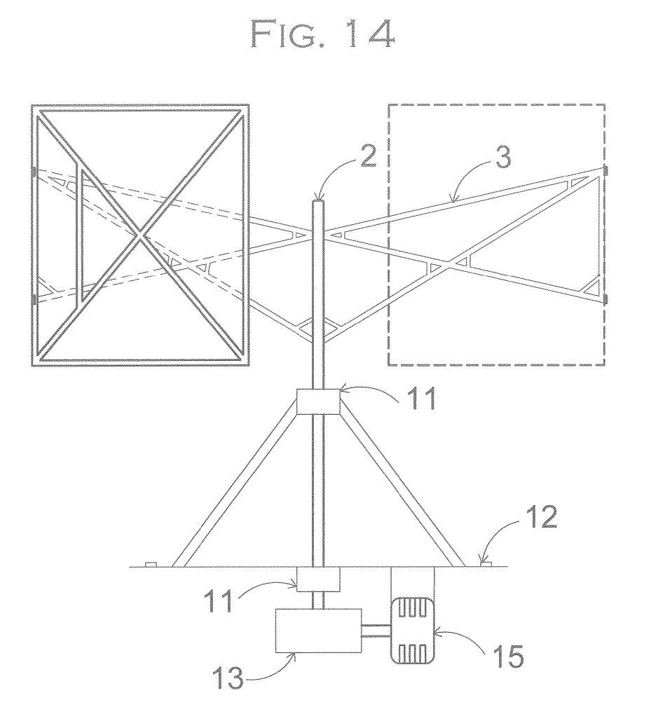

FIG. 3 is a front view of the panel 4 of the apparatus of FIG. 1 with one method of welded/attached cross beams 7 to provide additional structural support. The panel 4 comprises a frame 8 and panel fabric 9 stretched across the panel frame 8. The panels 4 can be made with aluminum tubing or other lightweight structural materials such as carbon fiber, with nylon or other similar synthetic sail materials, the more modern but more expensive Kevlar® sail material or solid thin sheeting such as PVC stretched across the frame. Additionally, in other embodiments, the panel 4 may comprise a flat solid material. For example, for the watermill embodiment of the present invention, the panel 4 may be made of a solid and thicker marine plastic or other durable product. The structural arms 3 can also be made of aluminum or other lightweight material tubing such as carbon fiber. Despite having a minimal number of moving parts, the apparatus 1 maintains maximum effectiveness. The structural arms 3 can be large and light, with a cross supported geometrical design that can hold the necessary weight of the various desired panel sizes. As an example, I believe that three 100′ high×50′ wide or 5,000 square foot panels should not be disregarded as impractical or improbable for this invention. The apparatus 1 can span a width of approximately 150 feet and a height of approximately 120 feet when rotating, leaving approximately 20 feet between the ground or other rigid structure such as a building and the bottom of the moving components of the apparatus 1 (see FIG. 14).

FIG. 4 is a top view of the apparatus 1 with panel 4a horizontal to the wind or water current, thereby having a minor effect on drag. Panel 4b has already flipped and is causing a minimal level of drag as it begins to return to its structural arm 3b. Panel 4c is acting like a sail, catching the wind and serving as the primary source of the clockwise motion of the apparatus 1. The structural arms may cause some drag; however, if the arms are made with streamlined/aerodynamic tubing, the drag level can be minimized.

FIG. 5 is a top view of the apparatus 1 with panel 4a starting to flip open as the wind or water current catches the back of the panel, causing it to open. The ball bearing hinges 5 allow for rapid flipping action (see FIG. 13). Panel 4b is still in the open position staying horizontal to the wind or water current, but at this point is starting to swing back towards the structural arm 3b. Panel 4c is still the primary driver of the apparatus 1.

In FIG. 6, panel 4a as now fully opened by the wind or water current, with the swing of the panel's momentum driving its structural arm 3a in the clockwise direction. Panel 4b is now parallel with its structural arm 3b and is still creating a minor level of drag. The wind or water current helps to keep panel 4b horizontal to its structural arm 3b. Panel 4c is still the primary driver.

As FIG. 7 shows, panel 4a is now parallel with the wind at its maximum open position of 90°, with the wind helping to maintain panel 4a in the desired direction, therefore reducing the drag. Panel 4b has now reached a point where it is now being pushed to the left by the wind assisting in maintaining the clockwise direction of the apparatus 1. Panel 4c is still a primary driver, but is now joined by panel 4b as the clockwise rotation continues. The momentum created by the various aspects of each panel's movements appears to be substantial and will assist in providing consistent power.

In FIG. 8, panel 4a begins to close, maintaining its parallel position with the wind/water current. As noted above, various methods can be applied to assist in bringing panel 4a in towards its structural arm 3a in the event that the centrifugal force is greater than the wind's ability to maintain the panel in a horizontal position to the wind. Panel 4b is now a primary driver for the clockwise direction of the apparatus 1. Panel 4c has reached the 0°/360° position and is close to entering the flipping portion, as it will pass the beginning point of the cycle. Once the wind or water current gets behind panel 4c as the panel rotates past the 0°/360° position, it will begin to flip open.

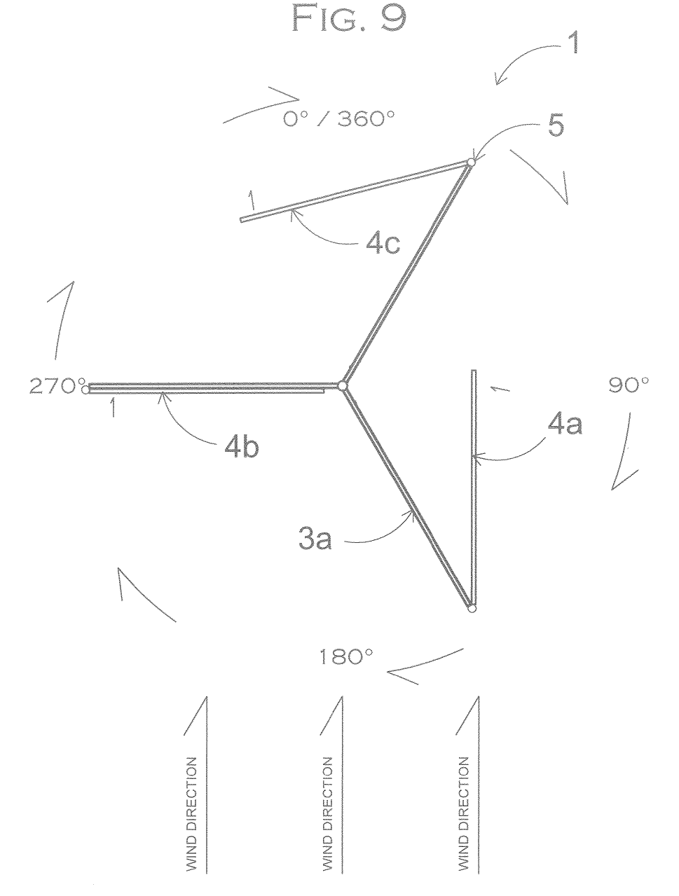

As FIG. 9 illustrates, panel 4c is beginning to flip open as the wind or water current catches the back of the panel. The ball bearing hinges 5 allow for rapid flipping action. Panel 4a is in the open position staying horizontal to the wind/water current while starting to swing back towards its structural arm 3a. Panel 4b is the primary driver of the apparatus 1.

In FIG. 10, Panel 4c is fully opened by the wind or water current. The swing of the panel's momentum, as it hits its 90°± stop, is driving its structural arm 3c in the clockwise direction. Panel 4a is now parallel with its structural arm 3a and continues to create a minor level of drag. The wind/water current helps to keep it horizontal to its structural arm. Panel 4b is the primary driver.

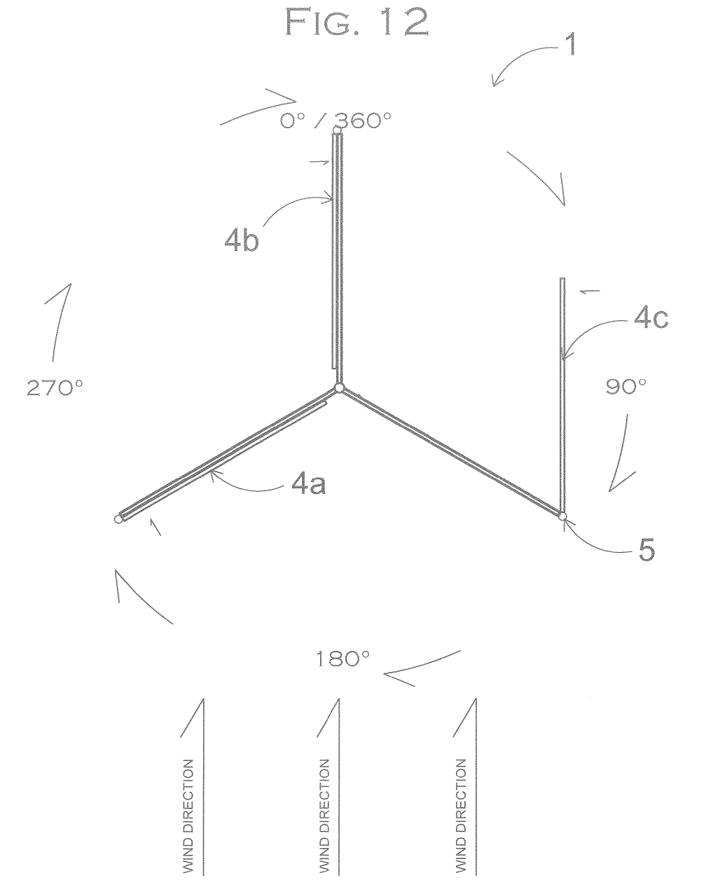

FIGS. 11 and 12 are a continuation of the panel actions as the panels reach the various positions in the clockwise rotation of the windmill. FIGS. 11 and 12 are similar to FIGS. 7 and 8, with panel 4c in the same position as panel 4a in the earlier figures.

FIG. 13 is a diagram of the ball bearing hinge 5 design, showing a fixed structural arm 3 and a swiveling panel 4. The panel 4 can swivel out to 90°-135°, depending on the strength of the wind or water current. One potential hinge design shown in this figure allows for the structural arm 3 and the panel 4 to maintain adequate distance so as not to damage one another as the panel 4 swings back to a horizontal position to the structural arm 3. It is also designed so that the panel 4 could swing past its 90° to 135° stop in the event that the wind/water current speed approaches a point in which a catastrophic failure of the apparatus 1 becomes likely. It should be noted that the hinge assemblies 5 may be fitted with other known mechanisms to allow the panels 4 to easily rotate.

Several possible arrangements exist for transferring the power harnessed by the apparatus 1 through its vertical axis spindle 2 and securing the entire apparatus 1 to an object. One such method, as described in FIG. 14, attaches the structural arms 3 directly to the spindle 2, which acts as a drive shaft to the applied usage. The bearings 11 are housed and securely fastened to an object 12. The spindle 2 is connected to a transmission means 13, which is in turn connected to a power generator system 15.

The various mechanical, hydraulic or pneumatic mechanisms may be applied to the apparatus 1 to act as dampeners as well as controllers of the flipping/swing rate. In addition to pulling the panels 4 back to their parallel position with their structural arms 3 in higher winds or water current speeds, such mechanisms dampen the contact points between the 90° to 135° stop and the structural arms. More specifically, they are designed to do three things: (1) Dampen the contact points between the swinging panel 4 as it makes contact with its 90° to 135° stop and its structural arm 3 once it swings back to its parallel position next to the structural arm 3; (2) control the rate of speed of the flipping action of the panels 4 under higher wind/water current speed conditions; and (3) assist in closing the panels 4 under such conditions as the centrifugal force of the spin overpowers the wind/water current by pulling the panels 4 back to a parallel position with their structural arms 3. FIG. 15 is a perspective view of a hydraulic strut 16 that could be attached to the panel of the apparatus 1 to enable said apparatus to withstand higher speed winds or water currents. FIG. 16 is a perspective view of a closed loop hydraulic system with a rotary actuator 17 that may be incorporated into each hinge assembly to control the motion of the panels. A standard four bar mechanical system, a pneumatic system, or any other system known in the art are other potential methods for controlling the panels.

Although the invention has been described with reference to a particular arrangement of parts, features and the like, these are not intended to exhaust all possible arrangements or features, and indeed many other modifications and variations will be ascertainable to those of skill in the art.

What is claimed is:

1. An apparatus for capturing kinetic energy, comprising:
a vertical axis spindle;
a plurality of structural arms having proximal ends attached to said vertical axis spindle; and
a plurality of panels wherein said panels are rotatably attached to distal ends of their respective structural arms along a vertical pivotal axis at remotest position from said spindle for movement between a folded position horizontally alongside said respective structural arms and an open position angled to said respective structural arms, wherein said pivotal axis extends vertically along an edge of each said panel.

2. The apparatus according to claim 1, further comprising a plurality of hinge assemblies for rotatable attachment of said panels to said distal ends of said respective structural arms.

3. The apparatus according to claim 1, wherein kinetic energy is captured from wind.

4. The apparatus according to claim 1, wherein kinetic energy is captured from any type of fluid flow energy.

5. The apparatus according to claim 1, wherein said open position for said panels is at ±90° to said respective structural arms.

6. The apparatus according to claim 1, wherein said open position for said panels is at ±135° to said respective structural arms.

7. The apparatus according to claim 1, wherein said structural arms have a cross supported geometrical design.

8. The apparatus according to claim 1, wherein said structural arms are comprised of lightweight tubing material.

9. The apparatus according to claim 1, wherein each said panel comprises a frame and material stretched across said frame.

10. The apparatus according to claim 1, wherein each said panel comprises a flat solid material.

11. The apparatus according to claim 9, wherein said frame comprises a lightweight tubing material.

12. The apparatus according to claim 9, wherein said material is a synthetic sail material.

13. The apparatus according to claim 1, wherein said panels are shaped to reduce resistance to currents and to assist in pulling the panels back into the structural arms.

14. The apparatus according to claim 1, further comprising a plurality of struts for dampening contact points between said panels and said hinge assemblies as the panels reach said open position angled to said respective structural arms, and between said panels and said respective structural arms as the panels rotate to said folded position parallel to the structural arms.

15. The apparatus according to claim 14, wherein said struts are mechanically actuated.

16. The apparatus according to claim 14, wherein said struts are hydraulically actuated.

17. The apparatus according to claim 14, wherein said struts are pneumatically actuated.

18. The apparatus according to claim 14, wherein said struts are engaged to pull said panels back to said folded position horizontally alongside said respective structural arms to control rate of speed of the rotational movement of said panels.

19. The apparatus according to claim 1, further comprising a rotary actuator fitted within each said hinge assembly and engaged to dampen contact points between said panels and said hinge assemblies as the panels reach said open position angled to said respective structural arms, and between said panels and said respective structural arms as the panels rotate to said folded position parallel to the structural arms, and to pull said panels back to said folded position horizontally alongside said respective structural arms to control rate of speed of the rotational movement of said panels.

20. The apparatus according to claim 1, wherein each said hinge assembly is fitted with ball bearings for more efficient engagement of the panels.

21. An apparatus for capturing kinetic energy from wind and any type of fluid energy comprising:
a vertical axis spindle;
a plurality of structural arms having proximal ends attached to said vertical axis spindle;
a plurality of panels wherein said panels are rotatably attached to distal ends of their respective structural arms along a vertical pivotal axis at remotest location from said spindle for movement between an open position angled to said respective structural arms and a folded position horizontally alongside said respective structural arms, wherein said pivotal axis extends vertically along an edge of each said panel; and
a plurality of struts arranged to dampen contact points between said panels and said hinge assemblies as the panels reach said open position angled to said respective structural arms, and between said panels and said respective structural arms as the panels rotate to said folded position parallel to the structural arms, and to pull said panels back to said folded position horizontally alongside said respective structural arms to control rate of speed of the rotational movement of said panels.

22. An apparatus for generating power comprising:
a vertical axis spindle;
a plurality of structural arms having proximal ends attached to said vertical axis spindle;
a plurality of panels wherein said panels are rotatably attached at their edges to distal ends of their respective structural arms along a vertical pivotal axis at remotest location to said spindle for movement between a folded position horizontally alongside said respective structural arms and an open position angled to said respective structural arms; and an energy converting system coupled to said spindle for converting first type of energy into second type of energy.

23. The apparatus according to claim 22, wherein the energy converting system comprises a transmission rotatably connected to said spindle, and a power generating system coupled to said transmission.

24. The apparatus according to claim 22, wherein the first type of energy is captured from wind.

25. The apparatus according to claim 22, wherein the first type of energy is captured from any type of fluid flow.

26. The apparatus according to claim 22, further comprising a plurality of struts for dampening contact points between said panels and said hinge assemblies as the panels reach said open position at the angle to said respective structural arms, and between said panels and said respective structural arms as the panels rotate to said folded position parallel to the structural arms.

27. The apparatus according to claim 26, wherein said struts are arranged to pull said panels back to said folded position to control rate of speed of the rotational movement of said panels.
